(19) United States
(12) Patent Application Publication
(10) Pub. No.: US 2019/0137439 A1
(43) Pub. Date: May 9, 2019

(54) HALF-CELL FOR MEASURING A pH VALUE, METHOD FOR PRODUCING A HALF-CELL, AND POTENTIOMETRIC SENSOR

(71) Applicant: Endress+Hauser Conducta GmbH+Co. KG, Gerlingen (DE)

(72) Inventor: Thomas Wilhelm, Chemnitz (DE)

(21) Appl. No.: 16/184,968

(22) Filed: Nov. 8, 2018

(30) Foreign Application Priority Data
Nov. 8, 2017 (DE) 10 2017 126 130.3

(51) Int. Cl. G01N 27/36; G01N 27/416; C03B 23/207; C03B 9/32

(52) U.S. Cl. CPC G01N 27/36; C03B 9/32; C03B 23/207; G01N 27/4167

(57) ABSTRACT

A half-cell for measuring a pH value of a measuring medium is disclosed including a tube-shaped carrier element and a pH-sensitive glass membrane connected to an end section of the carrier element. At least the end section of the carrier element includes a zirconia-containing and/or alumina-containing ceramic. A method for manufacturing a half-cell for pH value measurement and a potentiometric sensor are further disclosed.

### CROSS-REFERENCE TO RELATED APPLICATION

The present application is related to and claims the priority benefit of German Patent Application No. 10 2017 126 130.3, filed on Nov. 8, 2017, the entire contents of which are incorporated herein by reference.

### TECHNICAL FIELD

The present invention relates to a half-cell for measuring a pH value, as well as to a method for producing a half-cell and a potentiometric sensor.

### BACKGROUND

Half-cells for pH value determination are widely used and known in various designs. A corresponding glass electrode is, for example, known from DE 10 2013 114 745 A1. In this case, a glass electrode with a glass membrane and with an electrode shaft made of a lead glass or with a segmental lead glass surface is described.

The pH half-cell described in DE 10 2013 114 745 A1 has impedances between 50 megaohm (MΩ) and 1 gigaohm (GΩ). Measuring with a glass electrode of such high impedance is not trivial and requires good electrical insulation of the entire pH sensor and good shielding against electrical influences. One solution to the high impedance problem is carried out by fusing the pH glass membrane onto the inner tube, filling the half-cell, and conducting the potential discharge away via a platnium (Pt) wire and fusing it in the rear region of the inner tube. In doing so, the thermal expansion coefficient of the inner tube, the glass membrane, and the shaft of the outer tube should be adapted to that of Pt. An alternative approach for improvement consists in the inner tubes in many cases being closed at the rear by adhesion so that a silver wire of the inner electrode can be fed through to a plug.

Basically, the thermal expansion coefficients of all glass and ceramic components of a pH single-rod measuring cell are adapted to the expansion coefficient of Pt. Lead glass lends itself as material for the glass components because it has a suitable expansion coefficient, insulates well electrically, and has good softening and processing properties and because glass-to-glass sealing surfaces can be produced easily without cracks. The use of lead glass has proven itself per se, but the availability of lead glass has progressively decreased in recent times, so that procurement of the material presents a challenge.

One alternative solution is lamp glass. This has the advantages of good processability, but no longer in each and every case. Since lighting has, moreover, been practically completely converted to LED, it is more and more difficult to obtain affordable glass tubes in the required quality.

### SUMMARY

The present disclosure provides an alternative to known electrode shaft materials or other carrier elements for a glass membrane, which is suitable for the application of pH measurement without loss of measurement performance.

A half-cell according to the present disclosure for measuring a pH value of a measuring medium comprises a tube-shaped carrier element and a pH-sensitive glass membrane connected to an end section of the carrier element. According to the present disclosure, at least the end section of the carrier element consists of a zirconia-containing and/or alumina-containing ceramic. The ceramic can advantageously have a content of zirconia, for example, zirconium dioxide, and/or alumina of at least 80 wt %.

Zirconium dioxide (ZrO₂)is suitable as material for a carrier element, for example, for a shaft tube for outwardly delimiting the half-cell, because it is chemically virtually inert and thus also biocompatible, has a suitable expansion coefficient, is mechanically stable and can be fused in glass well. In addition or alternatively to zirconia, alumina (Al₂O₃) can also be used as a carrier element, for example, as a shaft tube for outwardly delimiting the half-cell. The aforementioned materials may also be used for a ceramic for forming a ceramic inner tube. Alternatively, Al/Zr mixed ceramics (e.g., ZTA, zirconia-toughened alumina) can also be used as material for a carrier element.

Unlike in some variants of glass electrodes, the ceramic/glass interfaces in the form of fusing regions are, in the present disclosure, kept as small as possible to minimize the risk of cracks, flaws, and/or other electrolyte penetrations. In at least one embodiment of a half-cell according to the present disclosure, the carrier element in a terminal region on an opposite side of the end section is not fused with glass but instead may, advantageously, have a medium-tight, for example, form-fit or firmly-bonded, closure, such as an adhesive closure or a closure cast with polymer.

In a region of the end section, the inner tube is connected to the shaft tube. In an embodiment, the inner tube is connected to the shaft tube without fusing. The connection can be achieved via a diaphragm, for example, via a polytetrafluoroethylene (PTFE) diaphragm or a porous ceramic diaphragm, which is inserted into the shaft tube.

Other embodiments of the present disclosure are the subject matter of the dependent claims. In an embodiment, the carrier element may exclusively consist of ceramic. In at least one embodiment, the tube-shaped carrier element may be designed as an inner tube, which, in interaction with a shaft tube, such as the aforementioned shaft tube, delimits an annular chamber with the reference electrolyte, wherein the inner tube defines the inner circumference of the annular chamber. In certain embodiments, in terms of manufacturing, the tube-shaped carrier element may consist completely of the zirconia-containing ceramic.

The composition of individual known components and aggregates of the ceramic may be selected such that the thermal expansion coefficient of the tube-shaped carrier element is adapted to the other components of the sensor. In an embodiment, the ceramic can advantageously be stabilized with an yttrium compound and/or an alkaline earth metal compound. In a further embodiemnt, the glass membrane may be fused onto the end section of the carrier element. In certain embodiments, the ceramic material is formed as an all-ceramic.

A method according to the present disclosure for producing a half-cell according to the present disclosure includes the following steps: a) providing a ceramic tube; b) fusing/blowing a pH-sensitive glass membrane onto one end of the ceramic tube; and c) providing an assembly of a tube-shaped shaft tube and a pH-sensitive glass membrane connected to an end section of the shaft tube. In an embodiment, at least the end section of the shaft tube consists of a zirconia-containing or alumina-containing ceramic, wherein the ceramic preferably has a content of zirconia and/or alumina of at least 80 wt %.

A potentiometric sensor according to the present disclosure includes a half-cell according to the present disclosure with a potential-forming element, which may be an Ag/AgCl electrode. The potential-forming element may, via an ion-conductive or mixed-conductive transition, for example, through a reference electrolyte, such as a buffered potassium chloride solution of known concentration, e.g., 3 molar KCl, or, for example, a polyacrylamide gel, be in contact via the glass membrane with the measuring medium adjacent thereto. Because the membrane resistances of the glass membrane are in the megaohm to gigaohm range, the glass membrane must be connected or joined to the shaft tube in an absolutely tight manner, without any electrical or electrolytic bypasses, i.e., no resistances in the teraohm range.

By fusing by blowing or melting, absolutely tight connection or joining is achieved. However, in this fusing process, a transition zone with undefined chemical composition and unpredictable influences on the measuring behavior of the sensor may form in glasses, which are avoided when using a ceramic and/or a ceramic coating. Moreover, ceramics are less prone to breaking than glass.

### BRIEF DESCRIPTION OF THE DRAWINGS

The invention shall be explained in more detail below with reference to a specific exemplary embodiment and with the aid of the enclosed figures. Shown is:

FIG. 1 shows a pH sensor including a potentiometric single-rod measuring cell, including a half-cell according to the present disclosure.

### DETAILED DESCRIPTION

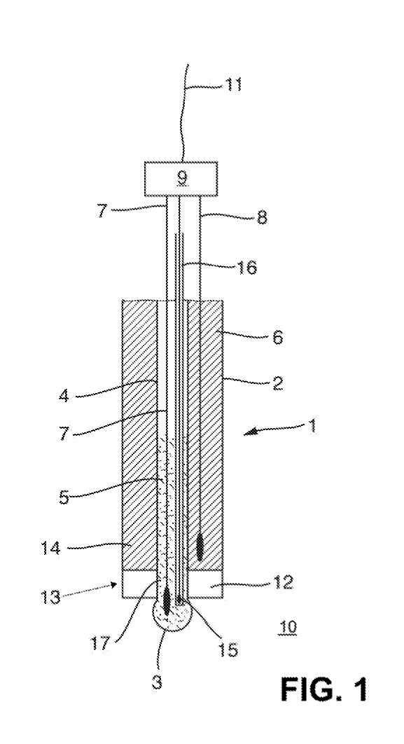

FIG. 1 shows a potentiometric sensor 1 for pH measurement, which is embodied as a single-rod measuring cell. The sensor 1 includes an outer shaft tube 2, which is connected in a front end section 13 to an inner tube 4 via an annular diaphragm 12, which enables an electro-chemical transition and is spaced apart from this inner tube 4. The outer shaft tube 2 separates the potentiometric sensor 1 from a measuring medium 10 or from the environment. The diaphragm 12 may be manufactured as a plastic molded body, for eaxmple, of PTFE, and may be connected in a form-fit manner, e.g., by force fit or bonded joint, e.g., by gluing or spraying-on, to the outer shaft tube 2. Alternatively, the diaphragm may be a porous, ceramic molded body.

Via the diaphragm 12, the measuring medium 10, surrounding the sensor 1, in the front end section 13 is in contact with a reference electrolyte 6 of the sensor 1. The inner tube 4 and the glass membrane 3 define a first chamber 17, in which an inner electrolyte 5, e.g., a buffer solution, is arranged. A discharge element 7, which is electrically conductively connected to a measuring circuit 9, is immersed in the inner electrolyte 5. A temperature sensor 15, which may be protected with a capillary tube 16, as shown in FIG. 1, may be immersed in the inner electrolyte 5.

The inner tube 4 extends coaxially to the outer shaft tube 2, such that an annular chamber 14 filled with the reference electrolyte 6 is disposed between the inner tube 4 and the outer shaft tube 2.

The reference electrolyte 6 may, for example, be a highly concentrated, e.g., 3 molar, KCl solution solidified by polymer contents, e.g., polyacrylamide, to a cross-linked hydrogel. A reference element 8 that is connected to the measuring circuit 9 in an electrically conductive manner may be immersed in the reference electrolyte 6. In certain embodiments, the reference element 8 may be protected by a capillary tube, which is open at an end, where appropriate. In the present example embodiment, the reference element 8 and the discharge element 7 are chloridated silver wires.

At a rear end opposite the front end section 13 connected to the glass membrane 3, the outer shaft tube 2 and the inner shaft tube 4 are sealed in a liquid-tight manner (not shown in FIG. 1). The liquid-tight seal may be achieved, for example, by a stopper that is bonded to the inner tube 4 and the outer shaft tube 2 or by using a polymer cast section. In an alternative embodiment, the glass and ceramic components may be fused together in rear end section.

The measuring circuit 9 may be accommodated in an electronics housing attached to the rear end of the outer shaft tube 2. The measuring circuit 9 may be configured to detect a difference in potential between the discharge element 7 and the reference element 9 and to generate a measuring signal that represents this difference in potential. The measuring signal can be output via a cable connection 11 to a higher-level data processing unit (not shown in FIG. 1), e.g., a transmitter, transducer, processor, computer, or programmable logic controller.

In the present example, at least one section of the inner tube 4, which is hereafter also called a carrier element, consists of a zirconia-containing and/or alumina-containing ceramic.

The sensor according to the present disclosure can preferably have a sensor impedance in the range of 50 MΩ to 1 GΩ.

In the context of the present disclosure, a multitude of other design variants are possible. In another embodiment, a short ceramic tube may be arranged as a carrier element injected and/or glued into a plastic tube. In such an embodiment, for example, in an embodiment having a sensor impedance of 1 GΩ, a bypass can be avoided. For example, the zirconia-containing and/or alumina-containing ceramic may have a composition according to the following table:

TABLE 1
Ceramic Composition by Embodiment

| Embodiment | Component of the Ceramic | Proportion (in wt %) |
|---|---|---|
| Composition 1 | ZrO₂ | 85-99% |
| | Y₂O₃ | 1-15% |
| Composition 2 | ZrO₂ | 93-97% |
| | Y₂O₃ | 3-7% |
| Composition 3 | ZrO₂ | 88-92% |
| | ZrO₂ | 8-12% |

Certain embodiments may include other components as stabilizers (e.g., MgO and/or CaO), the ZrO₂ component may have a proportion of at least 80%. In such an embodiment, the ZrO₂ component may have a proportion of 87-92%. The remaining proportion in the ceramic may be the respective stabilizer.

For example, Y-stabilized ceramics are particularly chemically stable and mechanically and thermally resistant and have a suitable expansion coefficient, which enables the material connection to the glass membrane 3, even with respect to a sufficient thermal shock resistance. In alternative embodiments, the Al₂O₃ component may have a proportion of more than 85% (in wt %).

The proportion of the total mass of the ceramic can thus be expressed as follows:

$$\frac{{m}_{ZrO 2} + {m}_{Al 2 O 3}}{{m}_{total}} \geq 80 wt \% - preferably , \geq 90 wt \%$$

Embodiments including Y₂O₃ amy have a content of ≤10% of stabilizers and a content of ≤20% of alkaline earth metals.

Ideally, the ceramic should have a preferred density, in order to avoid diffusion losses of the electrolyte. The preferred porosity of the ceramic is specified in relation to the true density. In certain embodiments, the specification may be:

$$\frac{{ρ}_{bulk}}{{ρ}_{true}} \geq 90 \% - preferably , \geq 95 \%$$

The specification corresponds to the comparison of the ceramic density (i.e, true density) to the maximum theoretical density (i.e., bulk density).

In embodiments for the reduction of material transitions, the inner tube 4 may consist completely of the zirconia-containing and/or alumina-containing ceramic.

The pH-sensitive glass of which the glass membrane 3 is formed may include a multi-component glass comprising a prespecified lithium oxide proportion.

The zirconia-containing and/or alumina-containing ceramic may be formulated as an all-ceramic, as generally known from other technical fields, e.g., ceramic engineering.

In comparison to carrier elements of lead glass, the zirconia-containing and/or alumina-containing ceramic has the special advantage of widespread use and sustained availability as a result of the various fields of application in ceramic engineering, filter ceramics, and medical engineering. Carrier elements of zirconia-containing and/or alumina-containing ceramic are, moreover, significantly tougher (i.e., break-proof) than lead glass. In addition, as in the embodiment of FIG. 1, no contamination of the glass membranes occurs as a result of the formation of mixed zones due to fusing.

The half-cell with the glass membrane 3 and the carrier element, i.e., the inner shaft tube 4, may be used as a component of the potentiometric sensor, in which undesired measuring effects are prevented as a result of the low contamination of the glass membrane.

The zirconia-containing and/or alumina-containing ceramic is, moreover, shatterproof and non-toxic, such that the pH half-cell may also be disposed of more easily in case of accidental damage and may be used in food applications where appropriate.

Claimed is:

1. A half-cell for measuring a pH value of a measuring medium, the half-cell comprising:
a tube-shaped carrier element having an end section; and
a pH-sensitive glass membrane connected to the end section of the carrier element, wherein at least the end section of the carrier element includes a zirconia-containing and/or alumina-containing ceramic.

2. The half-cell of claim 1, wherein the ceramic has a content of zirconia and/or alumina of at least 80% by weight.

3. The half-cell of claim 1, wherein the ceramic has a content of zirconia and/or alumina of at least 90% by weight.

4. The half-cell of claim 1, further comprising a shaft tube, wherein the carrier element is disposed at least partially within the shaft tube such that the shaft tube and the carrier element define an annular chamber, the annular chamber containing a reference electrolyte, wherein the carrier element defines the inner circumference of the annular chamber.

5. The half-cell of claim 1, wherin the carrier element consists of the zirconia-containing and/or alumina-containing ceramic.

6. The half-cell of claim 1, wherein the ceramic is stabilized with a yttrium compound and/or an alkaline earth metal compound.

7. The half-cell of claim 6, wherein the ceramic is stabilized with a yttrium oxide and/or an alkaline earth metal oxide.

8. The half-cell of claim 6, wherein the yttrium compound and/or alkaline earth metal compound has a content of equal to or less than 20% by weight in the ceramic.

9. The half-cell of claim 6, wherein the yttrium compound and/or alkaline earth metal compound has a content of equal to or less than 10% by weight in the ceramic.

10. The half-cell of claim 1, wherein the ceramic is an all-ceramic.

11. The half-cell of claim 1, wherein the ceramic has a density of:
$$\frac{{ρ}_{bulk}}{{ρ}_{true}} \geq 90 \%$$

12. The half-cell of claim 11, wherein the ceramic has a density of:
$$\frac{{ρ}_{bulk}}{{ρ}_{true}} \geq 95 \%$$

13. The half-cell of claim 1, further comprising a reference electrode, wherein the glass membrane and/or the reference electrode is connected to the end section of the carrier element via a diaphragm.

14. The half-cell of claim 13, wherein the diaphragm is an annular molded body, which is disposed in the shaft tube with a bonded joint and in which the glass membrane and/or the carrier element is attached by a form fit and/or adhesion.

15. The half-cell of claim 13, wherein the diaphragm is a plastic molded body or a porous ceramic molded body.

16. The half-cell of claim 13, wherein the diaphragm is a plastic molded body of polytetrafluoroethylene.

17. A method for manufacturing a half-cell for measuring a pH value of a measuring medium, the method comprising:
providing an inner tube having an end section;
fusing and/or blowing a pH-sensitive glass membrane onto the end section of the inner tube; and
assembling the inner tube with the membrane within a shaft tube, wherein at least the end section of the inner tube includes a zirconia-containing and/or alumina-containing ceramic.

18. A potentiometric sensor comprising:
a half-cell including:
a tube-shaped carrier element having an end section; and
a pH-sensitive glass membrane connected to the end section of the carrier element, wherein at least the end section of the carrier element includes a zirconia-containing and/or alumina-containing ceramic.

19. The potentiometric sensor of cliam 18, wherein the the ceramic has a content of zirconia and/or alumina of at least 80% by weight.

20. The potentiometric sensor of cliam 18, wherein the ceramic is stabilized with a yttrium compound and/or an alkaline earth metal compound.
